(19) United States
(12) Patent Application Publication
(10) Pub. No.: US 2002/0078551 A1
(43) Pub. Date: Jun. 27, 2002

(54) Method of fabricating thin-film magnetic head

(75) Inventor: Yoshinori Ohtsuka, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/055,315

(22) Filed: Oct. 29, 2001

Related U.S. Application Data
(63) Continuation of application No. PCT/JP99/03515, filed on Jun. 30, 1999.

(51) Int. Cl. G11B 5/127; H04R 31/00

(52) U.S. Cl. 29/603.07; 29/603.16; 360/125

(57) ABSTRACT

The present invention relates to a method of fabricating a thin-film magnetic head. A magnetic block is formed on a non-magnetic layer laminated on a lower pole. At least the non-magnetic layer is etched using the magnetic block as a mask, whereby a gap layer is formed. An insulation layer is formed in a predetermined thickness on the lower pole so as to cover the gap layer and the magnetic block. The insulation layer and the magnetic block are polished using an upper surface of the insulation layer as a polishing stop surface, whereby an upper sub-pole is formed. Then, an upper pole wider than the upper sub-pole is formed on the upper sub-pole. By this, the thickness of the upper sub-pole can be accurately set. By adopting such an upper sub-pole, recording track density can be enhanced.

### BACKGROUND OF THE INVENTION

1. Field of the Invention

The present invention relates to a method of fabricating a thin-film magnetic head used in a magnetic disk device or a magnetic tape device, and particularly to a method of fabricating a thin-film magnetic head comprising a small-width upper sub-pole opposed to a lower pole with a gap layer therebetween.

2. Description of the Related Art

Magnetic disk devices (disk drives) are used as recording devices for computers. A magnetic disk device comprises a magnetic disk as a recording medium, and a thin-film magnetic converter called head for writing and/or reading data, within a housing (or a disk enclosure). The magnetic disk is driven by a motor to rotate at a high speed, whereas the head is mounted on a slider having a special shape for providing air bearing given by the high-speed rotation of the magnetic disk and is driven in the radial direction of the magnetic disk by an actuator.

A thin-film magnetic writing head is desirable in view of enhancing surface density (the amount of data stored per unit surface area of the disk), and a thin-film magnetic reading head is desirable in view of its high resolution. In addition, since a multiplicity of heads can be fabricated on a ceramic substrate by use of various thin film fabricating processes and can then be divided into individual heads, the thin-film magnetic head can be easily fabricated.

An induction type thin-film writing head comprises a lower pole and an upper pole which are each composed of a thin film of a magnetic material. The lower pole and the upper pole are magnetically connected by a back gap at a back region, and respectively have pole ends on the side of an air bearing surface (ABS). The two pole ends are separated by a gap layer formed of a non-magnetic material. A coil constituted of a conductor is patterned so as to intersect with the lower pole and the upper pole. A magnetic flux induced in the lower pole and the upper pole by the coil leaks from the respective pole ends toward the recording medium, bypassing the gap layer. Data is written on the recording medium by the thus leaking flux. Thus, the pole ends of the lower pole and the upper pole are the last elements for guiding the magnetic flux to the recording medium. Therefore, the width of the pole ends is extremely important.

In order to enhance the amount of data stored per unit surface area of the disk (surface density), it is necessary for the writing head to write more data on narrower tracks of the disk. Therefore, enhancement of the surface density can be achieved by reducing the thickness of the gap layer between the pole ends. By reducing the thickness of the gap layer, bit density in the track is enhanced. The enhancement of the surface density can also be achieved by increasing the number of data tracks the writing head records on the disk. A parameter expression related to this is the track density or TPI (the number of tracks per inch). The TPI capability of the writing head can be enhanced by reducing the head size which determines the width of the data track. Ordinarily, the size is called track width of the head.

A magneto-resistance effect element (MR element) whose resistance varies in response to a magnetic flux density from a rotating magnetic disk is used in an MR reading head. A sense current flowing through the MR element varies in proportion to the variation of the resistance of the MR element. Therefore, by connecting a preamplifier to the MR element, a read signal can be processed. The MR element is provided by a thin film layer sandwiched between the lower shield layer and an upper shield layer. The distance between the lower shield layer and the upper shield layer is called read gap. As the read gap is smaller, the resolution of the MR reading head is higher.

Recently, an MR composite head composed by combining the MR reading head with an induction type writing head is used as a thin-film magnetic head. In the MR composite head, the upper shield layer of the MR head is used as a lower pole of the writing head. Thus, a thin film layer serves as the upper shield layer of the MR reading head and as the lower pole of the writing head, whereby one of fabrication steps is omitted. Another one of the advantages of the MR composite head resides in that position matching of the reading head and the writing head can be easily carried out on a single suspension system, for reading immediately after writing.

However, in the structure of the MR composite head at present, the upper shield layer functioning also as the lower pole must be large in width for protecting the MR element. At the time of writing, therefore, the recording magnetic field spreads in the track width direction, whereby the minimum track width achievable is limited.

To cope with this problem, it may be proposed to reduce the width of the upper pole at the pole end. However, to form the upper pole, patterning on a high step due to a coil and an interlayer insulation layer is needed. For example, in the case of applying a resist to a location where a high step is present, the film thickness of the resist corresponding to the high position is about 6 μm, whereas the film thickness of the resist corresponding to the low position is about 10 μm. The pole end of the upper pole to be reduced in width is located at the low position where the film thickness of the resist is large, so that it is extremely difficult to set the width of the pole end of the upper pole to be not more than 1 μm.

The minimum track width achievable can be reduced by trimming the pole end by use of a focused ion beam (FIB). However, the trimming of the pole end by use of the FIB is very poor in productivity. For example, in the case where trimming is conducted by use of the FIB in a wafer process, the trimming time per head is about 10 sec, so that about one day is consumed for one wafer where ten thousand (10,000) heads are obtained from one wafer. Therefore, in order to enhance throughput, it is necessary to either shorten the trimming time or introduce a large number of FIB equipments, which is not realistic.

In the wafer process, the pole end may be trimmed by ion milling, whereby the minimum track width achievable can be reduced (See, for example, Japanese Patent Laid-open No. Hei 7-262519). In this method, it suffices to apply ion milling at least one time per wafer, so that mass production property is good. However, resist exposure at a high step is needed, and it is difficult to form a pattern of not more than 1 μm in size.

In recent years, formation of a narrow upper sub-pole opposed to the lower pole with a gap layer therebetween at a pole end portion of the upper pole has been tried. By use of such an upper sub-pole, the minimum track width achievable can be reduced.

To form the upper sub-pole, for example, an upper pole small piece may be formed at the pole end portion separately from the upper pole, prior to formation of a coil pattern. Where an upper pole small piece is formed on the flat gap layer before formation of the coil pattern, formation of a pattern at a high step is unnecessitated, so that an upper pole small piece with a sufficiently small width can be obtained by suppressing the thickness of the photoresist. By laminating an upper pole on the upper pole small piece, an induction type writing head comprising a narrow upper sub-pole can be provided.

In the head comprising an upper sub-pole, it is desirable that the thickness of the upper sub-pole along the recording track direction is set in a predetermined range. For example, if the thickness of the upper sub-pole is too small, the upper pole flanging in the recording track width direction from both sides of the upper sub-pole leads to generation of smearing of records. As a result, it becomes impossible to enhance the recording track density as expected. On the other hand, if the thickness of the upper sub-pole is too large, recording field intensity is lowered, and, in the worst case, it becomes impossible to write data on a recording medium.

Japanese Patent Laid-open No. Hei 9-270105 discloses a method in which the upper pole small piece is covered by a non-magnetic insulating film and the surface of the non-magnetic insulating film is polished to be flat, prior to formation of a coil pattern. According to the flattening polishing, the upper pole small piece is exposed to be flush with the surface of the non-magnetic insulating film. Since an upper pole layer is laminated on the exposed upper pole small piece, the thickness of the upper sub-pole is varied according to the amount of polishing in the flattening polishing. Accordingly, it is not easy to accurately control the thickness of the upper pole small piece at the time of the flattening polishing.

### SUMMARY OF THE INVENTION

Accordingly, it is an object of the present invention to provide a method of fabricating a thin-film magnetic head in which the thickness of an upper sub-pole of a writing head can be accurately set. The other objects of the invention will become apparent from the following description.

According to the present invention, a method of fabricating a thin-film magnetic head is provided. First, a lower pole having a substantially flat upper surface is formed. A non-magnetic layer is formed on the upper surface of the lower pole. A magnetic block is formed on the non-magnetic layer. At least the non-magnetic layer is etched using the magnetic block as a mask, whereby a gap layer having substantially the same width as the width of the magnetic block is formed between the lower pole and the magnetic block. An insulation layer is formed in a predetermined thickness on the lower pole so as to cover the gap layer and the magnetic block. The insulation layer and the magnetic block are polished using the upper surface of the insulation layer corresponding to an edge portion of the lower pole as a polishing stop surface, whereby an upper sub-pole is formed. An upper pole wider than the upper sub-pole is formed on the upper sub-pole.

According to this method, the upper surface of the insulation layer having a predetermined thickness can be used as the polishing stop surface, so that the thickness of the upper sub-pole can be accurately set. For example, the predetermined thickness of the insulation layer can be so set that the thickness of the upper sub-pole falls within a predetermined range.

Desirably, a polishing stop pattern for providing the polishing stop surface is formed around the lower pole. By this, the area ratio between the portion to be polished and the portion not to be polished can be set large at the time of forming the upper sub-pole by polishing by use of the polishing stop surface, so that the timing to stop polishing can be easily determined based on the variation of wearing related to the polishing. In this meaning, the polishing stop pattern desirably includes a plurality of patterns. The polishing stop pattern can be a part or the whole part of a terminal for connecting the thin-film magnetic head to an external circuit.

A lower sub-pole can be formed as one body with the lower pole by etching a part of the lower pole using the magnetic block and the gap layer as a mask, at the time of forming the gap layer by etching.

Thus, according to the invention, a thin-film magnetic head comprising an upper sub-pole having an accurately set thickness can be provided. By use of the head, it is possible to prevent the generation of smearing of records, to thereby enhance the recording track density and to enhance the intensity of a recording magnetic field. Therefore, by using the head, the amount of data stored per unit surface area of the disk in a magnetic disk device can be increased.

Thus, according to the present invention, there is provided a magnetic disk device having a large recording capacity and being small in size. The magnetic disk device comprises a housing (disk enclosure), a magnetic disk capable of being driven to rotate in the housing, and a magnetic head capable of access to a recording region of the magnetic disk. The magnetic head can be fabricated by the method of the present invention.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCIPTION OF THE DRAWINGS

FIG. 1 is a plan view showing the internal structure of a hard disk drive as an embodiment of a magnetic disk device to which the present invention is applicable;

FIG. 2 is a perspective view of a head slider shown in FIG. 1;

FIG. 3 is a sectional view of a thin-film magnetic head shown in FIG. 2;

FIG. 4 is a plan view generally showing the strucure of an induction type writing head element shown in FIG. 3;

FIG. 5 is a perspective view of the vicinity of a tip end portion of the induction type writing head element shown in FIGS. 3 and 4;

FIGS. 6A to 6C are figures generally showing the fabrication steps of a head slider;

FIGS. 7A to 7H are figures showing the fabrication steps of a thin-film magnetic head;

FIG. 8 is a sectional view of one example of the thin-film magnetic head obtained by the fabrication steps shown in FIGS. 7A to 7H; and

FIG. 9 is a figure for illustrating an example of layout of polishing stop patterns.

### DESCRIPTION OF THE PREFERRED EMBODIMENTS

Hereinafter, a preferred embodiment of the present invention will be described in detail referring to the attached drawings. In similar figures, the same symbols denote similar or the same component parts.

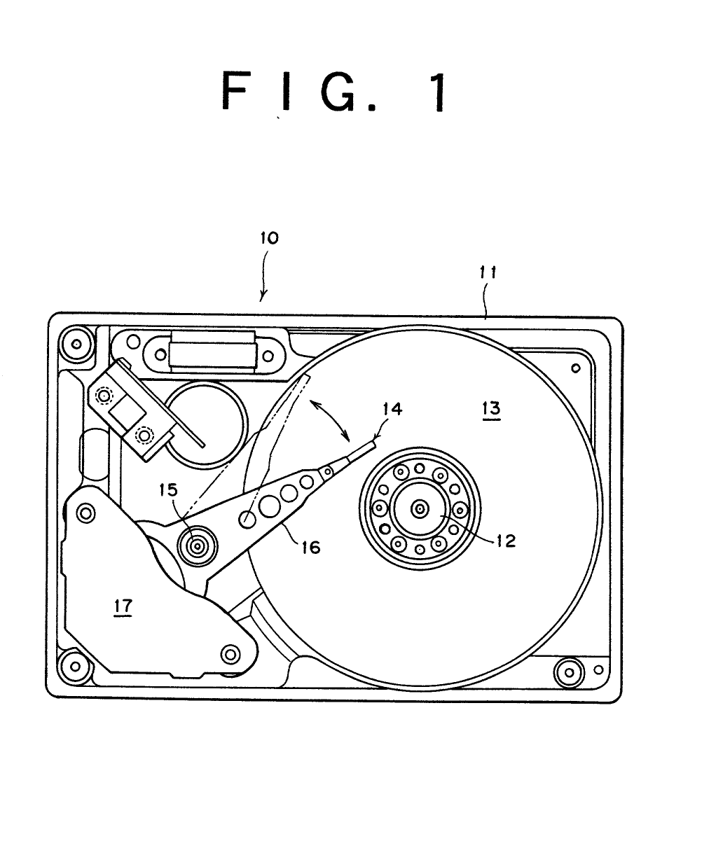

FIG. 1 is a plan view showing the internal structure of a hard disk drive (HDD) 10 as an embodiment of a magnetic disk device according to the present invention. In a housing 11 of the hard disk drive 10, a magnetic disk 13 fitted to a rotating shaft 12 of a motor not shown and a head slider 14 opposed to the magnetic disk 13 are contained. The head slider 14 is attached to the tip end of a carriage arm 16 capable of oscillation around an oscillating shaft 15. As to the writing and reading of data onto and from the magnetic disk 13, the carriage arm 16 is driven to oscillate by an actuator 17 including a voice coil motor (VCM) which is electrically controllable, and, as a result, the slider 14 is positioned at a desired recording track on the magnetic disk 13. Thus, by driving the actuator 17, the head slider 14 is capable of access to a recording region of the magnetic disk 13. The inside space of the housing 11 is closed by a cover not shown.

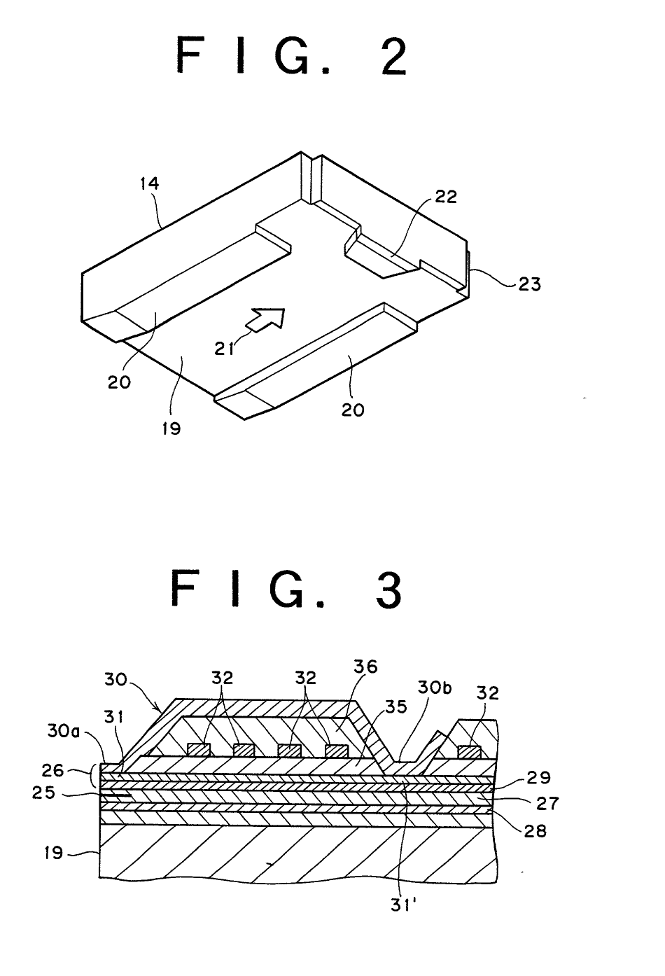

FIG. 2 is a perspective view showing an example of a head slider 14 shown in FIG. 1. The head slider 14 has a floating surface 19 opposed to the magnetic disk 13 (See FIG. 1). The floating surface 19 is provided with two rails 20 for providing an air bearing surface (ABS). The head slider 14 can be floated above the surface of the magnetic disk 13 by utilizing the pressure due to an air flow 21 received by the floating surface 19 (particularly, ABS) during rotation of the magnetic disk 13. A head incorporating film 23 in which a thin-film magnetic head 22 is incorporated is formed on an end face on the air outflow side of the head slider 14, as described later. Generally, the head slider 14 is formed of Al₂O₃ TiC (altic), and the bulk of the head incorporating film 23 is formed of A1₂O₃ (alumina).

FIG. 3 is a sectional view for generally illustrating the structure of the thin-film magnetic head 22 shown in FIG. 2. The head 22 comprises a magneto-resistance effect (MR) element 25 for reading data and an induction type writing head 26 for writing data, which front on the floating surface 19 (or ABS). The MR element 25 is embedded in an insulation layer 27, and is sandwiched between a lower shield layer 28 and an upper shield layer 29. For example, the insulation layer 27 is formed of Al₂O₃, and the shield layers 28 and 29 are formed respectively of NiFe or FeN.

The induction writing head element 26 comprises an upper pole 30 constituting a magnetic core together with a lower pole which functions also as the upper shield layer 29 of the MR element 25. The tip end (pole end) 30a of the upper pole 30 is faced to the upper shield layer (lower pole) 29 through a gap layer 31. By the gap layer 31, a writing gap is formed between the upper pole tip end 30a and the lower pole 29.

The rear end 30b of the upper pole 30 is magnetically connected to the lower pole 29 through a back gap 31′ substantially flush with the gap layer 31. A spiral coil pattern 32 is provided so as to intersect with the lower pole 29 and the upper pole 30. When an electric current flows in the coil pattern 32, a magnetic line of force is generated in the upper pole rear end 30b penetrating through the center of the coil pattern 32, and the magnetic line of force circulates through the upper pole 30 and the lower pole 29. The magnetic line of force thus circulating generates a magnetic field in the write gap.

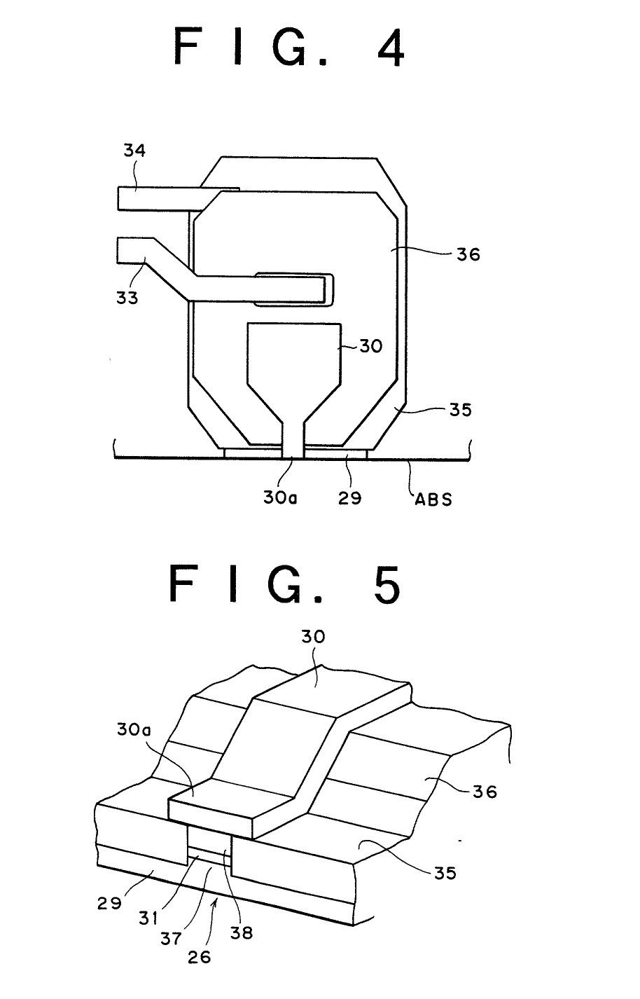

Referring to FIG. 4 also, a first lead wire 33 is connected to the center end of the coil pattern 32 located at the center of the spiral. A second lead wire 34 is connected to the outside end of the coil pattern 32 located at an outside edge of the spiral. An electric current can be passed in the coil pattern 32 through the first and second lead wires 33 and 34. The coil pattern 32 is sandwiched between a lower insulation layer 35 laminated on the gap layer 31 and an upper insulation layer 36 laminated on the lower insulation layer 35.

As is clear from FIG. 4, the upper pole tip end 30a fronting on the write gap at the ABS of the slider 14 (See FIG. 2) determines the recording track width on the magnetic disk 13 at the time of writing data. The magnetic line of force circulating through the upper pole 30 and the lower pole 29 passes from the upper pole tip end 30a faced to the magnetic disk 13 through the write gap to the lower pole 29.

FIG. 5 is a perspective view for detailed illustration of the structure of the vicinity of the tip end fronting on the write gap of the induction writing head 26 shown in FIGS. 3 and 4. The head element 26 comprises a lower sub-pole 37 rising from the lower pole 29. The lower sub-pole 37 may be formed as one body with the lower pole 29 by shaving the surface of the lower pole 29 by, for example, etching, as will be described later, or may be formed of a magnetic film newly formed on the lower pole 29.

An upper sub-pole 38 is laminated on the lower sub-pole 37, with the gap layer 31 therebetween. The sub-poles 37 and 38 and a corresponding portion of the gap layer 31 are laminated in the same pattern shape, and these three components are surrounded by the insulation layer, namely, the lower insulation layer 35. The upper surface of the upper sub-pole 38 is flush with a corresponding portion of the lower insulation layer 35, and the upper pole tip end 30a wider than the upper sub-pole 38 is laminated on the upper surface of the upper sub-pole 38.

Thus, according to the present embodiment, the lower sub-pole 37 and the upper sub-pole 38 are faced to each other with the gap layer 31 therebetween, between the lower pole 29 and the upper pole 30; therefore, a magnetic field can be generated in a narrower region as compared to the case where the sub-poles are absent, and swelling of the magnetic field at the write gap can be obviated. As a result, it is possible to write data without smearing of records on a recording medium such as the magnetic disk.

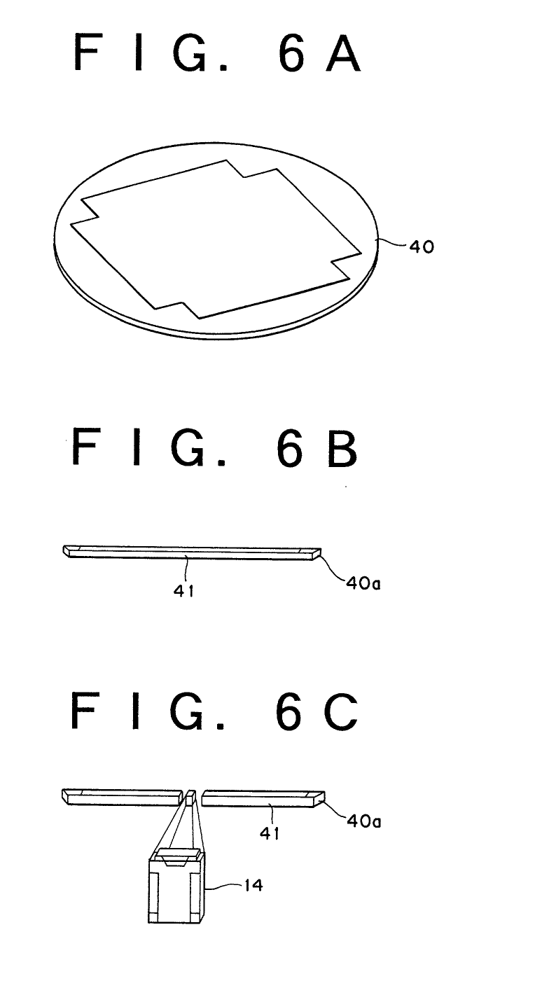

Next, a method of fabricating the head slider 14 shown in FIG. 2 will be described referring to FIGS. 6A to 6C. First, as shown in FIG. 6A, a multiplicity of thin-film magnetic heads 22 are formed on the surface of an Al₂O₃ TiC wafer 40 provided on its surface with an Al₂O₃ layer. The thin-film magnetic heads 22 are formed on the basis of one block cut out to be one head slider 14. In the case of a wafer with a diameter of 5 inches, for example, ten thousand (=100×100) head sliders can be cut out. The thin-film magnetic head 22 thus formed is covered with a non-magnetic insulating film of an Al₂O₃ layer.

Subsequently, as shown in FIG. 6B, a row bar 40a comprising a plurality of head sliders 14 in a row is cut out from the wafer 40 provided thereon with the thin-film magnetic heads 22. The floating surface 19 including two rails 20 described above is formed at a cut surface 41 of the row bar 40a thus cut out. Finally, as shown in FIG. 6C, the individual head sliders 14 are cut out from the row bar 40a.

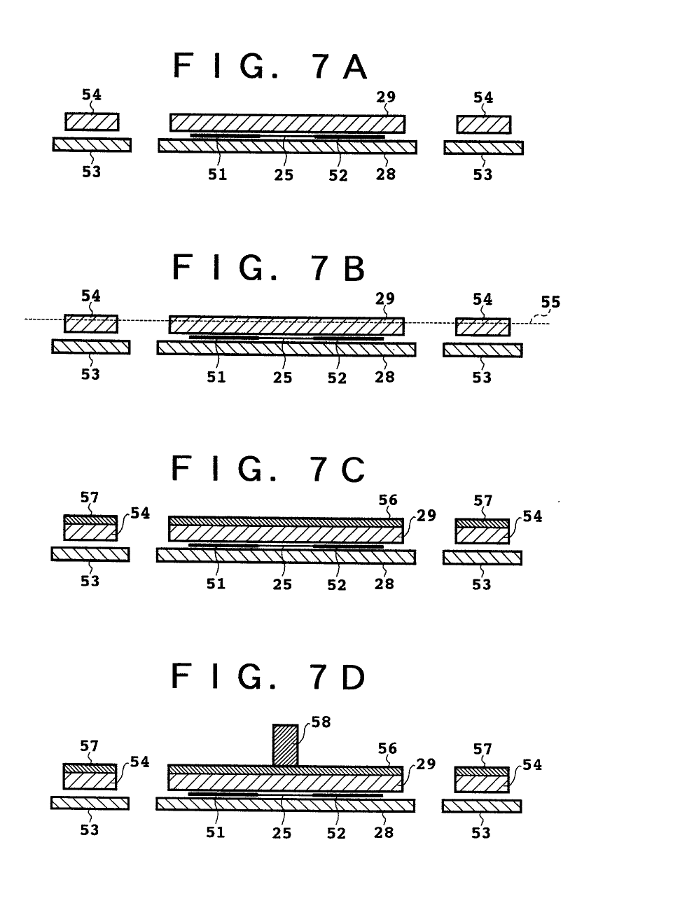

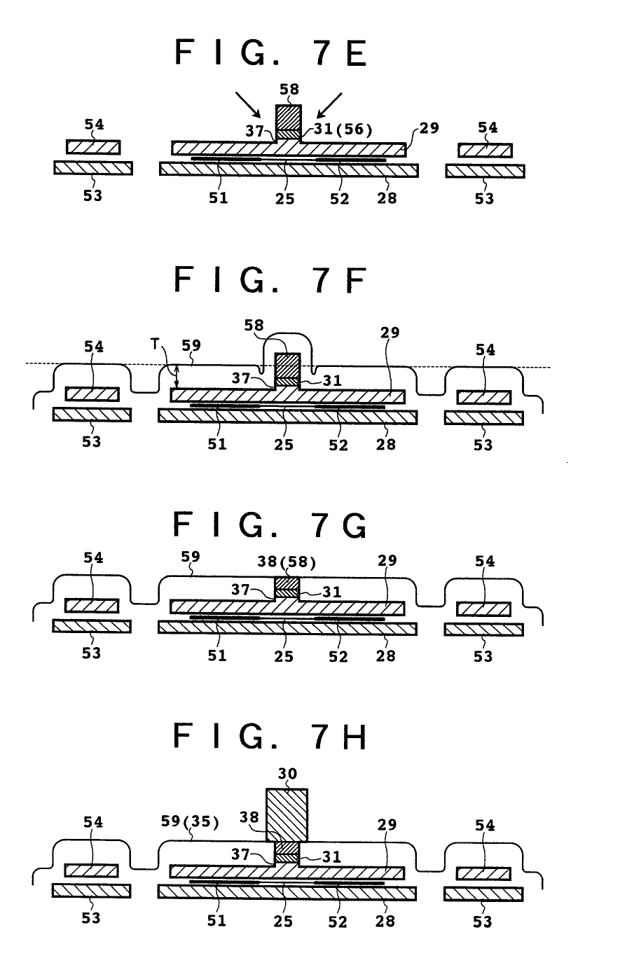

Now, referring to FIGS. 7A to 7H, a method of fabrication of the thin-film magnetic head 22 which is characteristic of the present invention will be described in detail. The embodiment of the method of fabrication is characterized in that a polishing stop surface 50 is set in order to obtain an upper sub-pole 38 (See, for example, FIG. 5) having a high thickness accuracy, as shown in FIG. 7F.

First, as shown in FIG. 7A, a lower shield layer 28, an MR element 25 and an upper shield layer (lower pole) 29 are laminated in this order on, for example, a wafer 40 (See FIG. 6A, not shown here). Symbols 51 and 52 denote a pair of electrodes for passing a sense current to the MR element 25. In parallel to this, in order to provide a polishing stop surface 50 (See FIG. 7F), a pair of patterns 53 are formed on both sides of the lower shield layer 28, and a pair of patterns (polishing stop patterns) 54 are laminated on the patterns 53. The patterns 53 can be formed from the same material and in the same process as the lower shield layer 28, and the patterns 54 can be formed from the same material and in the same process as the lower pole 29. Therefore, the upper surface of the patterns 54 can be easily conformed to the upper surface of the lower pole 29. Each of the lower shield layer 28 and the lower pole 29 as well as the patterns 53 and 54 can be obtained by, for example, plating with NiFe.

When the lower pole 29 is formed, recesses and projections may be formed in the surface of the lower pole 29, partly due to the presence of the MR element 25, namely, due to the difference in thickness between the MR element 25 and the electrodes 51 and 52. Therefore, in the present embodiment, as shown by symbol 55 in FIG. 7B, the upper surfaces of the lower pole 29 and the pattern 54 are polished to be flat. By this, the accuracy of film formation in the subsequent steps is enhanced, and the upper surfaces of the lower pole 29 and the pattern 54 can be positioned on substantially the same plane.

Subsequently, as shown in FIG. 7C, a non-magnetic layer 56 is formed on the upper surface of the lower pole 29, and, by the same process as this, a non-magnetic layer 57 is formed on the pattern 54. The non-magnetic layer 56 becomes the gap layer 31 later. The non-magnetic layers 56 and 57 can be formed of, for example, an oxide such as Al₂O₃ and SSO₂, Al nitride, Si nitride or a non-magnetic metal such as Ti and Ta.

Next, as shown in FIG. 7D, a magnetic block 58 for obtaining the upper sub-pole 38 (See FIG. 5) is formed on the non-magnetic layer 56 at a position corresponding roughly to the MR element 25. As a material for the magnetic block 58, a ferromagnetic alloy such as NiFe, CoNiFe and CoFe may be used. The magnetic block 58 is roughly a rectangular parallelopiped in shape, the height thereof can be set at 2 to 3 μm, and the depth thereof can be roughly equal to the depth (throat height) of the upper pole tip end 30a (See, for example, FIG. 5). In addition, since the upper surface of the non-magnetic layer 56 on which to form the magnetic block 58 is flat, the width of the magnetic block 58 can be set sufficiently small (for example, not more than 1 μm) by applying the usual photolithography, without taking into account the dispersion of the thickness of the photoresist due to the presence of a step or the like.

Next, as shown in FIG. 7E, at least the non-magnetic layer 56 is etched by, for example, ion milling using the magnetic block 58 as a mask. As a result, the gap layer 31 having substantially the same width as the width of the magnetic block 58 is formed between the lower pole 29 and the magnetic block 58. Particularly in this embodiment, at the time of this etching, a part of the lower pole 29 is further etched with the magnetic block 58 and the gap layer 31 as a mask. As a result, a lower sub-pole 37 is carved out from the surface of the lower pole 29. Therefore, in the region of the write gap, a laminate of the lower sub-pole 37 rising from the surface of the lower pole 29, the gap layer 31, and the magnetic block 58 is obtained. By thus carving out the lower sub-pole 37 by utilizing the magnetic block 58 as a mask, positional stagger is not generated between the lower sub-pole 37 and the upper sub-pole 38 which provide the write gap, so that smearing of records can be prevented from occurring. Besides, since the magnetic block 58 is formed immediately after the formation of the non-magnetic layer 56, dispersion of the gap layer 31 can be suppressed to be small. In contrast to this, in the case of the prior art, dispersion of the thickness of the gap layer has been large due to film loosing because of over-etching or the like.

Next, as shown in FIG. 7F, an insulation layer 59 is formed on the lower pole 29 and the pattern 54 so as to cover the gap layer 31 and the magnetic block 58. As a material for the insulation layer 59, for example, Al₂O₃ or SiO₂ may be adopted. A polishing stop surface 50 is determined by the thickness T of the insulation layer 59 at the flat surface of an edge portion of the lower pole 29. More specifically, the thickness T is so set that the thickness of the upper sub-pole 38 obtained in the subsequent step falls within a predetermined range. The thickness T of the insulation layer 59 is the same also on the pattern 54.

Subsequently, as shown in FIG. 7G, the insulation layer 59 related to the magnetic block 58 and the magnetic block 58 are polished using the polishing stop surface 50, to obtain the upper sub-pole 38. At the time of the polishing for flattening, the magnetic block 58 small in width would not fall due to the polishing pressure, because the magnetic block 58 is covered by the insulation layer 59. In the polishing for flattening, the thickness T of the insulation layer 59 determining the polishing stop surface 50 can be maintained. Namely, when parts of the insulation layer 59 and the magnetic block 58 projecting above the polishing stop surface 50 are carved away, the area of the portion making contact with the lapping surface is abruptly increased and wear is increased, and, as a result, for example, polishing speed is abruptly lowered; by detecting the abrupt lowering of the polishing speed and stopping the polishing, the thickness T of the insulation layer 59 is maintained.

Particularly in this embodiment, the polishing stop pattern 54 is provided corresponding to the lower pole 29, and the insulation layer 59 is formed thereon in the thickness T, so that the area ratio between the portion to be polished and the portion not to be polished can be set sufficiently large, and determination of the time to stop polishing can be conducted with high accuracy.

The non-magnetic layer 59 covering the lower pole 29 constitutes a part or the whole of the lower insulation layer 35 (See FIG. 3), and, as shown in FIG. 7H, an upper pole 30 wider than the upper sub-pole 38 is formed on the upper sub-pole 38 and the insulation layer 59. Prior to the formation of the upper pole 30, interlayer foreign matters such as a coil pattern 32 (See FIG. 3) are formed; however, since the formation of these can be carried out in the usual manner, so that the description thereof is omitted.

Here, examples of the thicknesses of individual portions will be described. The thickness of the magnetic block 58 shown in FIG. 7D is 2 to 3 μm, the thickness of the magnetic block 58 after etching shown in FIG. 7E is 1 to 2 μm, the thickness T of the insulation layer 59 shown in FIG. 7F is 1.5 to 2.5 μm, and in FIG. 7G, the thickness of the lower sub-pole 37 is 0.2 to 0.5 μm, the thickness of the gap layer 31 is 0.2 to 0.3 μm, and the thickness of the upper sub-pole 38 is 0.5 to 1.0 μm.

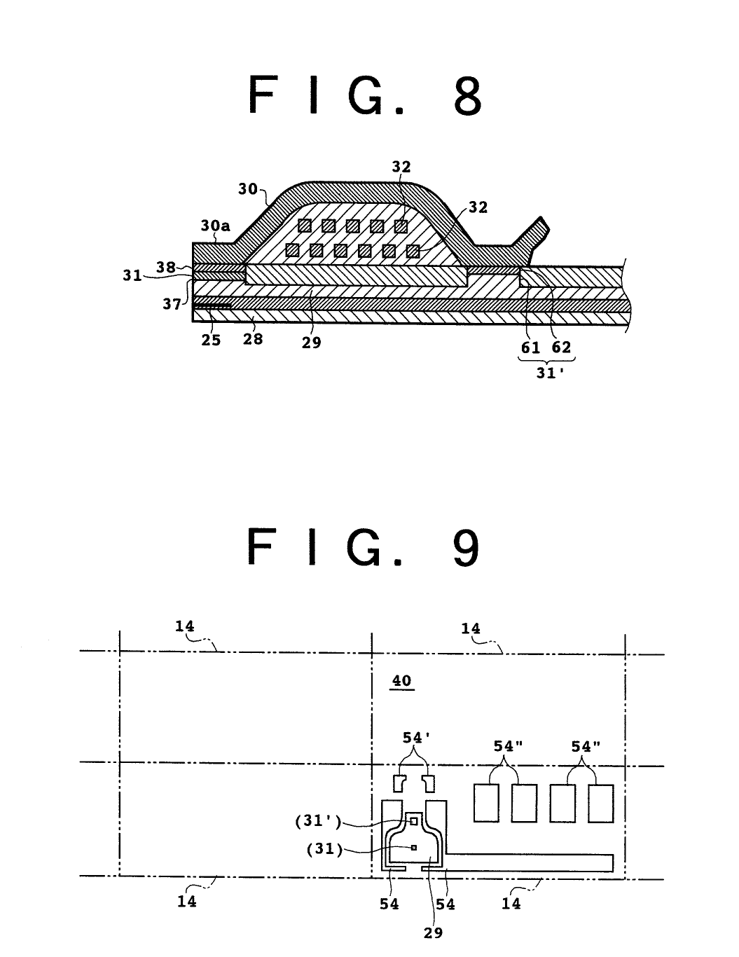

FIG. 8 is a sectional view showing an example of a thin-film magnetic head fabricated by the method shown in FIGS. 7A to 7H, and generally corresponds to FIG. 3. Here, the back gap 31′ electrically connecting the lower pole 29 and the upper pole 30 comprises a lower portion 61 formed as one body with the lower pole 29 correspondingly to the lower sub-pole 37, and an upper portion 62 formed correspondingly to the upper sub-pole 38. The upper portion 62 is disposed intermediately between the lower portion 61 and the upper pole 30. By thus forming the back gap 31′ from a magnetic material, the magnetic resistance between the lower pole 29 and the upper pole 30 can be reduced.

FIG. 9 is a plan view showing an example of the layout of the polishing stop patterns. As has been described referring to FIGS. 6A to 6C, a plurality of head sliders 14 are cut out from the wafer 40. Here, in each head slider 14, a pair of polishing stop patterns 54 are formed on both sides of the lower pole 29, and, further, two polishing stop patterns 54′ and four polishing stop patterns 54″ are formed. The patterns 54′ can constitute a part or the whole of a pair of terminals connected respectively to the electrodes 51 and 52 (See FIGS. 7E and 7D) of the MR element 25, and the patterns 54″ can constitute a part or the whole of four terminals for electrically connecting the thin-film magnetic head to an external circuit. For example, two of the patterns 54″ are connected to the electrodes 51 and 52 through the patterns 54′, and the remaining two of the patterns 54″ are connected to lead wires 33 and 34 (See FIG. 4) for the coil pattern 32. In the lower pole 29, the position corresponding to the gap layer 31 is denoted by (31), while the position corresponding to the back gap 31′ is denoted by (31′).

By thus forming a plurality of polishing stop patterns including the additional polishing stop patterns 54′ and 54″, the area ratio between the portion to be polished and the portion not to be polished at the time of polishing for flattening can be enlarged, so that determination of the timing for stopping the polishing can be carried out with a high accuracy. In addition, by using the polishing stop patterns 54′ and 54″ also as a part or the whole of the terminals, the plurality of polishing stop patterns can be easily formed.

While the polishing stop pattern 54 is formed around the lower pole 29 in order to enlarge the above-mentioned area ratio in the embodiment described referring to FIGS. 7A to 7H, the method of the present invention can be carried out without forming the patterns 53 and 54. In that case, in order to maintain the uniformity of the thickness T of the insulation layer 59 at the polishing stop surface 50 (See FIG. 7F), it is desirable that the polishing for flattening is carried out before cutting out the plurality of head sliders 14 from the wafer 40. By this, the wafer 40 is multi-point supported on a lapping surface by a multiplicity of portions to be polished, so that the portions not to be polished of the insulation layer 59 are prevented from being undesirably cut away, and the method of the present invention can be effectively carried out. Namely, the polishing can be stopped with appropriate timing, whereby the thickness of the upper sub-pole 38 can be set into a predetermined range.

While a portion of the lower pole 29 is etched using the magnetic block 58 and the gap layer 31 as a mask to thereby form the lower sub-pole 37 as one body with the lower pole 29 as shown in FIG. 7E in this embodiment, the present invention can also be applied to fabrication of a thin-film magnetic head which does not comprise a lower sub-pole.

While the lower pole 29 and the polishing stop pattern 54 are polished so as to remove recesses and projections in the upper surface of the lower pole 29 as shown in FIG. 7B in this embodiment, the polishing may be omitted where the recesses and projections in the upper surface of the lower pole 29 are on such a level that they do not cause any problem.

While the present invention has been applied to the fabrication of an MR composite head in the above embodiment, the present invention is not limited to the embodiment, and may be used for fabrication of an induction type writing head.

As has been described above, the present invention provides a method of fabricating a thin-film magnetic head in which the thickness of an upper sub-pole in an induction writing head can be set accurately. By use of a thin-film magnetic head obtained by the method, it is possible to prevent smearing of records, to enhance the recording track density on a magnetic disk, and to obtain a sufficient recording field intensity. Therefore, by use of the thin-film magnetic head, it is possible to increase the amount of data stored per unit surface area of the disk in a magnetic disk device.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A method of fabricating a thin-film magnetic head comprising the steps of:
forming a lower pole having a substantially flat upper surface,
forming a non-magnetic layer on said upper surface of said lower pole,
forming a magnetic block on said non-magnetic layer,
etching at least said non-magnetic layer using said magnetic block as a mask to form between said lower pole and said magnetic block a gap layer having substantially the same width as the width of said magnetic block,
forming an insulation layer in a predetermined thickness on said lower pole so as to cover said gap layer and said magnetic block,
polishing said insulation layer and said magnetic block using an upper surface of said insulation layer corresponding to an edge portion of said lower pole as a polishing stop surface to form an upper sub-pole, and
forming on said upper sub-pole an upper pole wider than said upper sub-pole.

2. A method as set forth in claim 1, further comprising the step of forming around said lower pole a polishing stop pattern for providing said polishing stop surface.

3. A method as set forth in claim 2, wherein said polishing stop pattern comprises a plurality of patterns.

4. A method as set forth in claim 2, wherein said polishing stop pattern provides a terminal for connecting said thin-film magnetic head to an external circuit.

5. A method as set forth in claim 1, wherein said step of forming said gap layer includes the step of etching a part of said lower pole using said magnetic block and said gap layer as a mask, whereby a lower sub-pole is formed as one body with said lower pole.

6. A method as set forth in claim 1, further comprising the step of forming a magneto-resistance effect element on a lower shield, wherein said lower pole is provided as an upper shield opposed to said lower shield with said magneto-resistance effect element therebetween.

7. A thin-film magnetic head fabricated by the method as set forth in claim 1.
